(19) United States
(12) Patent Application Publication
(10) Pub. No.: US 2025/0353365 A1
(43) Pub. Date: Nov. 20, 2025

(54) GLASS RUN CHANNEL AND GLASS RUN CHANNEL ASSEMBLY

(71) Applicant: TOKAI KOGYO CO., LTD., Obu-shi, Aichi (JP)

(72) Inventor: Yosuke KOBAYASHI, Obu-shi (JP)

(73) Assignee: TOKAI KOGYO CO., LTD., Obu-shi, Aichi (JP)

(21) Appl. No.: 18/872,560

(22) PCT Filed: Mar. 31, 2023
(86) PCT No.: PCT/JP2023/013707

§ 371 Date: Dec. 6, 2024

(30) Foreign Application Priority Data
Jun. 7, 2022 (JP) 2022-092570

(51) Int. Cl. B60J 10/76; B60J 10/16; B60J 10/21; B60J 10/32

(52) U.S. Cl. CPC B60J 10/76; B60J 10/16; B60J 10/17; B60J 10/21; B60J 10/32

(57) ABSTRACT

A glass run channel includes a lip portion in which a bending point is located on a root side of the lip portion. At the bending point, the lip portion is bent when the lip portion is elastically deformed by sliding with a window pane. A first covering portion having a friction coefficient smaller than that of the lip portion is formed on a distal end side of the lip portion with respect to the bending point. A second covering portion having a friction coefficient smaller than that of the lip portion is formed over a surface of a visible portion from the bending point of the lip portion or a position of the lip portion on the distal end side with respect to the bending point. The first covering portion is formed to be harder than the second covering portion.

### TECHNICAL FIELD

The present invention relates to a glass run channel attached along a window frame of a door panel of a vehicle and a glass run channel assembly.

### BACKGROUND ART

A glass run channel is attached to a channel (groove) of a window frame of a door panel of a vehicle, guides a peripheral edge of a window pane at the time of moving up and down the window pane (window glass), and seals between the window pane and the door panel when the window pane is closed. For example, in a glass run channel disclosed in Patent Literature 1 (JP2000-185558A), a lip portion on a vehicle interior side and a lip portion on a vehicle exterior side that are elastically deformable and protrude from ends of a sidewall portion on a vehicle interior side and a sidewall portion on a vehicle exterior side of a main body portion made of an elastic polymer material and having a U-shaped cross-section toward the inside of the main body portion are formed, and a soft synthetic resin coating layer containing a lubricant is formed on a surface of each lip portion on which the lip portion slides with a window pane in order to improve sliding.

### CITATION LIST

### Patent Literature

Patent Literature 1: JP2000-185558A

### SUMMARY OF INVENTION

### Technical Problem

In recent years, for reasons such as changing a lifting mechanism of a window pane from an arm type to a wire type, it is desired that a lip portion of a glass run channel easily slides with respect to the window pane, and a coating layer with a good sliding property may be formed on a surface of the lip portion as in Patent Literature 1.

However, the coating layer with a good sliding property is often harder than the lip portion. When the coating layer is formed to a root of the lip portion, a reaction force against bending deformation on a root side of the lip portion increases, and the window pane becomes difficult to move up or down. If the coating layer is not formed on the root of the lip portion, it is possible to prevent the reaction force against the bending deformation on the root side of the lip portion from increasing. However, when the glass run channel is attached to the window frame, an operator pushes the root side of the lip portion to slide along a longitudinal direction. Therefore, in order to improve the attachment workability of the glass run channel, the root of the lip portion also needs to have a sliding property.

Therefore, an object of the present invention is to provide a glass run channel and a glass run channel assembly capable of preventing an increase in reaction force against bending deformation on a root side of a lip portion while ensuring a sliding property of the lip portion with respect to a window pane and a sliding property on a root side of the lip portion which is a portion to be pushed by an operator during an attachment operation.

### Solution to Problem

In order to solve the above problem, the present invention provides a glass run channel made of an elastic polymer material, the glass run channel being configure to be attached along a window frame of a door panel of a vehicle and formed to be long to guide movement of a window pane, the glass run channel including: a main body portion having a U-shaped cross-section, the main body portion including a sidewall portion on a vehicle interior side, a sidewall portion on a vehicle exterior side, and a bottom wall portion integrally connecting both sidewall portions; a lip portion on the vehicle interior side and a lip portion on the vehicle exterior side that are elastically deformable and protrude from ends of the respective sidewall portions toward an inside of the main body portion; and a visible portion on the vehicle interior side and a visible portion on the vehicle exterior side that are elastically deformable and protrude from the ends of the respective sidewall portions toward an outside of the main body portion, in which at least one of the lip portions on the vehicle interior side and the vehicle exterior side is formed such that: a bending point is located on a root side of the lip portion, the bending point at which the lip portion is bent when the lip portion is elastically deformed by sliding with the window pane at a time of moving up or down the window pane; a first covering portion having a friction coefficient smaller than that of the lip portion is formed on a distal end side of the lip portion with respect to the bending point within a surface of the lip portion sliding with the window pane; and a second covering portion having a friction coefficient smaller than that of the lip portion is formed over a surface of the visible portion from the bending point of the lip portion or a position of the lip portion on the distal end side with respect to the bending point, and in which the first covering portion is formed to be harder than the second covering portion.

In this configuration, since the first covering portion having a friction coefficient smaller than that of the lip portion is formed on the surface of the lip portion sliding with the window pane, it is possible to ensure the sliding property required for an up/down movement operation of the window pane. Moreover, since the first covering portion formed on the surface of the lip portion is harder than the second covering portion formed on the surface of the visible portion, the sliding property is further enhanced, and the sliding property with respect to the window pane can be further improved. Further, the second covering portion having a friction coefficient smaller than that of the lip portion is formed over the surface of the visible portion from the bending point of the lip portion or the position of the lip portion on the distal end side with respect to the bending point. Therefore, when the operator pushes the glass run channel into the window frame and attaches the glass run channel, the operator can easily slide a portion from the root side of the lip portion to the surface of the visible portion by the second covering portion, which is a portion to be pushed in by hand to slide along a longitudinal direction, and the attachment workability of the glass run channel can be improved. Moreover, the first covering portion harder than the second covering portion is formed on the distal end side of the lip portion with respect to the bending point located on the root side of the lip portion, and the bending point on the root side of the lip portion is not covered by the harder first covering portion. Therefore, the bending deformation of the root side of the lip portion is not hindered, and an increase in reaction force against the bending deformation on the root side of the lip portion can be prevented.

Here, a durometer hardness (type D) defined in JIS K7215 of the first covering portion, which is a covering portion of the lip portion, is preferably set to be HDD 40 or more and HDD 60 or less. When the hardness of the first covering portion is within this range, it is possible to prevent a decrease in flexibility of the lip portion while ensuring a predetermined sliding property of the lip portion with respect to the window pane.

A durometer hardness (type A) defined in JIS K7215 of the second covering portion, which is a covering portion of the visible portion, is preferably HDA 80 or more and HDA 95 or less. When the hardness of the second covering portion is within this range, it is possible to prevent the lip portion from being lowered in its bendability at the bending point while ensuring a required sliding property of the visible portion during the attachment operation of the glass run channel.

It is preferable that the first covering portion and the second covering portion are formed to be in contact with each other. Accordingly, since the first covering portion and the second covering portion are continuously formed from the lip portion to the visible portion without a gap, the sliding property can be secured continuously from the lip portion to the visible portion.

A thickness of the second covering portion is preferably smaller than a thickness of the first covering portion. Accordingly, not only the bending deformation of the visible portion in which the second covering portion is formed is not hindered, but also the bending deformation on the root side of the lip portion is not hindered even when the bending point of the lip portion is covered with the second covering portion.

Specifically, the thickness of the first covering portion is preferably 0.1 mm or more and 0.4 mm or less. Since the thickness of the first covering portion is set to 0.1 mm or more, even when the first covering portion is worn due to the repetition of the up/down movement operation of the window pane, the first covering portion can be left on the surface of the lip portion, and the lip portion can always be easily slid with respect to the window pane. In addition, by setting the thickness of the first covering portion to 0.4 mm or less, it is possible to prevent the lip portion itself from being lowered in its elastic deformability by the first covering portion.

The thickness of the second covering portion is preferably 0.01 mm or more and less than 0.1 mm. In a case where the glass run channel is attached to the window frame of the door panel of the vehicle, when the operator pushes his/her hand into the root side of the lip portion of the glass run channel and the surface of the visible portion adjacent to the root side of the lip portion to slide along the longitudinal direction, the root side of the lip portion and the surface of the visible portion adjacent to the root side of the lip portion are slippery, and workability is good. In addition, by setting the thickness of the second covering portion to be less than 0.1 mm, even if the bending point of the lip portion is covered with the second covering portion, it is possible to prevent the lip portion from being lowered in its elastic deformability and deformability at the bending point.

When the glass run channel having the above-described configuration is applied to a glass run channel assembly including an upper side glass run channel attached along an upper side of a window frame of a door panel of a vehicle and a vertical side glass run channel attached along a vertical side of the window frame, the glass run channel having the above-described configuration may be applied to both the upper side glass run channel and the vertical side glass run channel, or the glass run channel having the above-described configuration may be applied to only the upper side glass run channel or only the vertical side glass run channel. In addition, when the glass run channel having the above-described configuration is applied to the vertical side glass run channel, the first covering portion is formed in the lip portion having a high frequency of sliding at the time of moving up or down the window pane, whereby the sliding property at the time of moving up or down the window pane is enhanced, and the effect of applying the present invention is significant.

### BRIEF DESCRIPTION OF DRAWINGS

FIG. 1 is a side view of a door on a front side of a vehicle.

FIG. 2 is a cross-sectional view of the glass run channel in a state where a window pane shown along a line II-II in FIG. 1 is opened.

FIG. 3 is a cross-sectional view of the glass run channel in a state where the window pane shown along the line II-II in FIG. 1 is closed.

FIG. 4 is an enlarged cross-sectional view of the vicinity of a root side of a lip portion on a vehicle interior side.

### DESCRIPTION OF EMBODIMENTS

Hereinafter, an embodiment in which an embodiment of the present invention is applied to a door on a front side of a vehicle and embodied will be described.

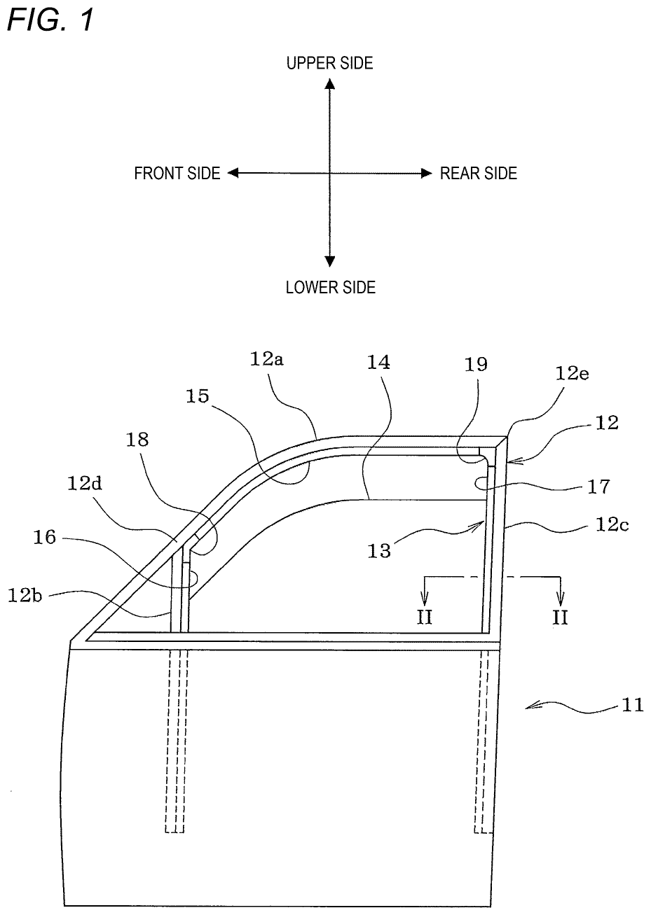

First, a schematic configuration of a door 11 on a front side will be described with reference to FIG. 1.

A window frame 12 is integrally provided at an upper half portion of the door 11, and a long glass run channel assembly 13 made of an elastic polymer material is attached to the window frame 12 to guide an up/down movement of the window pane 14 (window glass) along the window frame 12.

The glass run channel assembly 13 mainly includes an upper side glass run channel 15 attached to an upper side portion 12a of the window frame 12, a front vertical side glass run channel 16 attached to a vertical side portion 12b on a front side of the window frame 12, a rear vertical side glass run channel 17 attached to a vertical side portion 12c on a rear side of the window frame 12, a front molded corner portion 18 that connects the upper side glass run channel 15 and the front vertical side glass run channel 16 and is attached to a front corner portion 12d of the window frame 12, and a rear molded corner portion 19 that connects the upper side glass run channel 15 and the rear vertical side glass run channel 17 and is attached to a rear corner portion 12e of the window frame 12.

Each of the glass run channels 15 to 17 of the upper side portion and the front and rear vertical side portions of the glass run channel assembly 13 is formed by extrusion molding an elastic polymer material into a certain cross-sectional shape. The front and rear molded corner portions 18 and 19 are formed to connect ends of adjacent glass run channels by performing injection molding (insert injection molding) using an elastic polymer material between the ends.

Examples of the elastic polymer material forming the glass run channel assembly 13 include vulcanized elastic rubbers [typically, a material mainly containing an ethylene-propylene-diene rubber (EPDM)] and an olefin-based thermoplastic elastomer (TPO). The elastic polymer material forming the front and rear molded corner portions 18 and 19 is preferably compatible with and chemically bonded to an adjacent glass run channel to be connected to an end of the adjacent glass run channel when injection-molded.

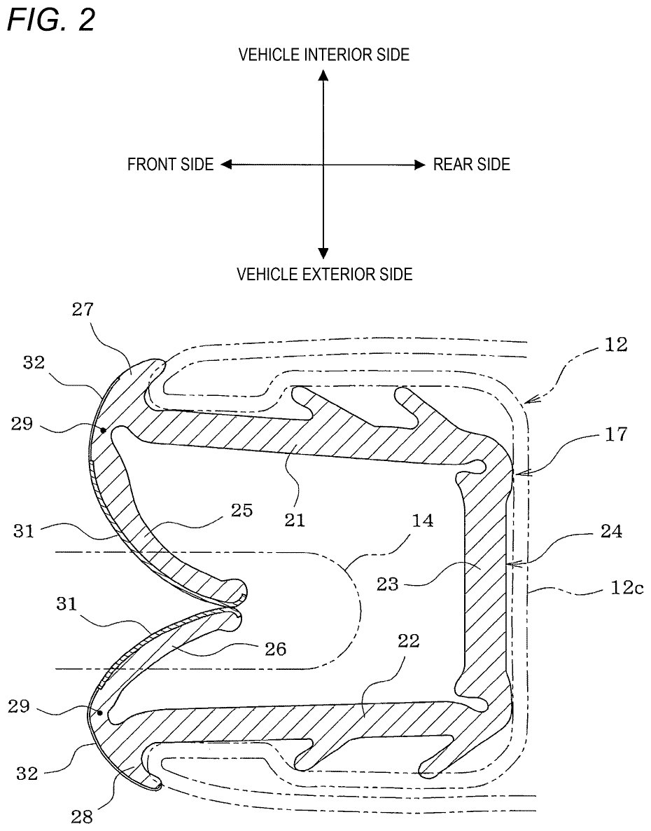

Next, a configuration of the rear vertical side glass run channel 17 will be described with reference to FIGS. 2 to 4. The front vertical side glass run channel 16 has the same configuration as the rear vertical side glass run channel 17, and the front and rear directions are merely reversed, so that the description of each portion of the front vertical side glass run channel 16 will be omitted.

As shown in FIG. 2, the vertical side glass run channels 16 and 17 include a main body portion 24 having a U-shaped cross-section and including a sidewall portion 21 on a vehicle interior side and a sidewall portion 22 on a vehicle exterior side, and a bottom wall portion 23 integrally connecting the sidewall portions 21 and 22 to each other, a lip portion 25 on a vehicle interior side and a lip portion 26 on a vehicle exterior side that are elastically deformable and protrude from ends of the respective sidewall portions 21 and 22 toward the inside of the main body portion 24, and a visible portion 27 on a vehicle interior side and a visible portion 28 on a vehicle exterior side that are elastically deformable and protrude from the ends of the respective sidewall portions 21 and 22 toward the outside of the main body portion 24.

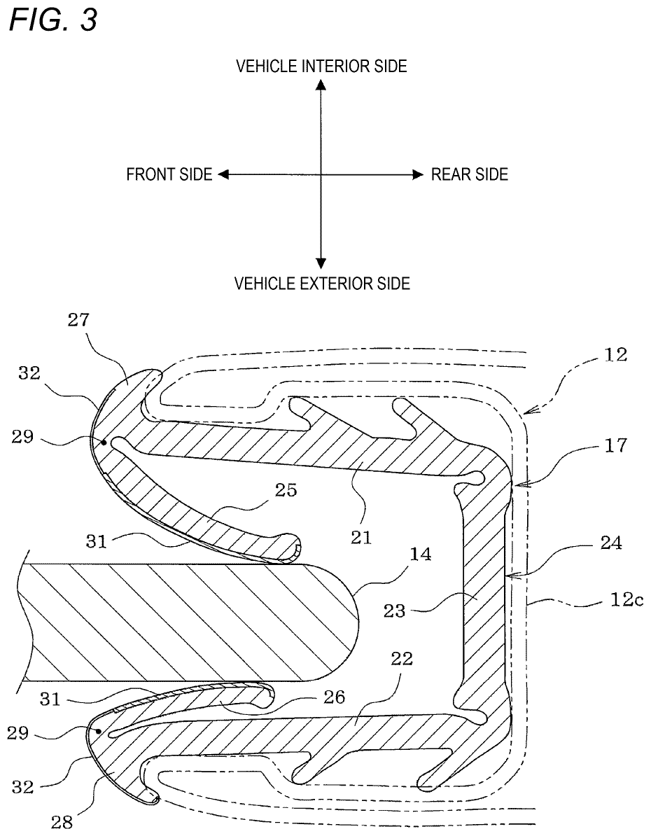

The lip portions 25, 26 on the vehicle interior side and the vehicle exterior side are formed such that the bending point 29 at which the lip portions 25, 26 are bent when the lip portions 25, 26 are elastically deformed by sliding with the window pane 14 at the time of moving up or down the window pane 14 is located on root sides of the lip portions 25, 26. In the present embodiment, a thickness of the lip portions 25 and 26 is smaller than that of other portions in the vicinity of the root, and a center of the thinnest portion in the vicinity of the root is the bending point 29. As shown in FIG. 3, when the window pane 14 rises and the window pane 14 enters the main body portion 24 of the rear vertical side glass run channel 17, the lip portions 25 and 26 are bent and elastically deformed at the bending point 29.

A first covering portion 31 having a friction coefficient smaller than that of the lip portions 25 and 26 is formed on a distal end side of the lip portions 25 and 26 with respect to the bending point 29 within surfaces of the lip portions 25 and 26 that slide with the window pane 14.

Further, a second covering portion 32 having a friction coefficient smaller than that of the lip portions 25, 26 is formed over surfaces of the visible portions 27, 28 from the bending point 29 of the lip portions 25, 26 or a position the lip portions 25, 26 on the distal end side with respect to the bending point 29.

In the present embodiment, a dynamic friction coefficient of the first covering portion 31 measured by a test method of ASTM-1894 is 1=0.2 or less, and a dynamic friction coefficient of the second covering portion 32 is 2=0.4 or less.

The first covering portion 31, which is a covering portion of the lip portions 25 and 26, is formed to be harder than the second covering portion 32, which is a covering portion of the visible portions 27 and 28.

Specifically, a durometer hardness (type D) defined in JIS K7215 of the first covering portion 31, which is the covering portion of the lip portions 25 and 26, is set to be HDD 40 or more and HDD 60 or less.

A durometer hardness (type A) defined in JIS K7215 of the second covering portion 32, which is a covering portion of the visible portions 27 and 28, is set to be HDA 80 or more and HDA 95 or less.

Further, a thickness of the second covering portion 32, which is the covering portion of the visible portions 27 and 28, is smaller than a thickness of the first covering portion 31, which is the covering portion of the lip portions 25 and 26. For example, the thickness of the first covering portion 31 is 0.1 mm or more and 0.4 mm or less, and the thickness of the second covering portion 32 is 0.01 mm or more and less than 0.1 mm.

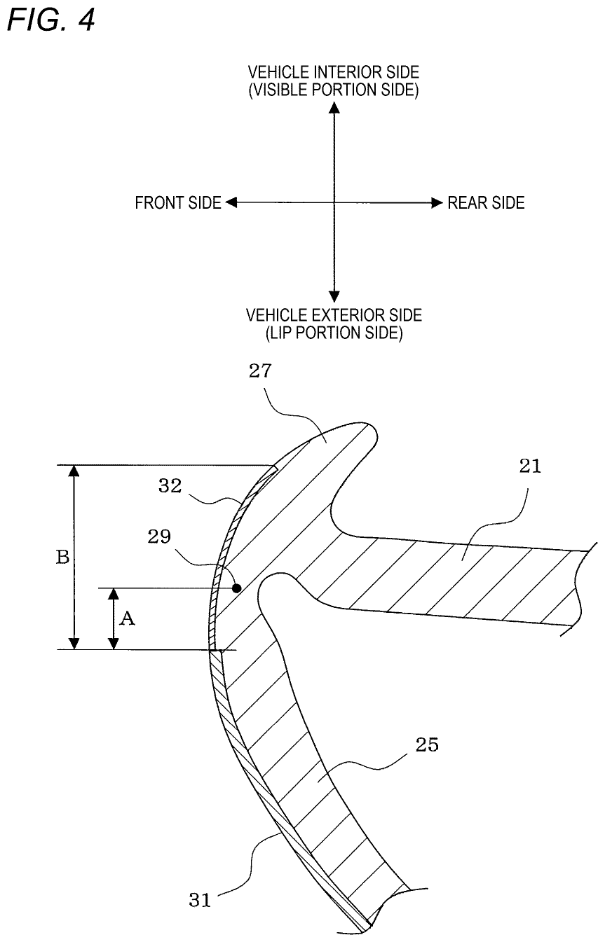

The first covering portion 31 and the second covering portion 32 are formed to be in contact with each other without a gap therebetween. As shown in FIG. 4, a boundary between the first covering portion 31 and the second covering portion 32 is set at a position away from the bending point 29 toward the lip portions 25 and 26 by a predetermined distance A (for example, 0.5 mm). In this way, even if the position of the boundary between the first covering portion 31 and the second covering portion 32 deviates due to manufacturing variations, the bending point 29 is not covered with the first covering portion 31, and the elastic deformation of the lip portions 25 and 26 is not hindered.

When the vertical side glass run channels 16 and 17 are attached to the window frame 12 having a U-shaped cross-section, the operator pushes the vertical side glass run channels 16 and 17 into grooves of the window frame 12 to slide on the root sides of the lip portions 25 and 26 of the vertical side glass run channels 16 and 17 and the surfaces of the visible portions 27 and 28 adjacent to the root sides of the lip portions 25 and 26 in the longitudinal direction. Accordingly, a portion extending from the root sides of the lip portions 25, 26 to the surfaces of the visible portion 27, which is a portion to be pushed by the operator when the operator pushes the vertical side glass run channels 16, 17 into the window frame 12 and attaches the glass run channels 16, 17 to the window frame 12, may be made slippery by the second covering portion 32. In this case, the second covering portion 32 may be formed on the entire surfaces of the visible portions 27 and 28. The second covering portion 32 may not be formed on the distal end sides of the visible portions 27 and 28 on which the operator does not slide his/her hand during the attachment operation even on the surfaces of the visible portions 27 and 28.

In the present embodiment, as shown in FIG. 4, the second covering portion 32 is formed on the surface of the visible portion 27 on the vehicle interior side in a portion where the operator slides his/her hand (a region from the boundary with the first covering portion 31 to a position separated by a predetermined distance B toward the visible portions 27 and 28) during the attachment operation. On the other hand, as shown in FIGS. 2 and 3, on the surface of the visible portion 28 on a vehicle exterior side, the second covering portion 32 is formed up to the distal end side of the visible portion 28 in consideration of the fact that the portion where the operator slides his/her hand from the vehicle exterior side during the attachment operation is larger than the visible portion 27 on a vehicle interior side.

The upper side glass run channel 15 may have the same configuration as the vertical side glass run channels 16 and 17 or may have different configurations. The upper side glass run channel 15 does not necessarily have the same configuration as that of the vertical side glass run channels 16 and 17 because a frequency of sliding of a lip portion on the window pane 14 at the time of moving up or down the window pane 14 is lower than that of the vertical side glass run channels 16 and 17. However, in the lip portion of the upper side glass run channel 15, it is desirable to form a covering portion having a friction coefficient smaller than that of the lip portion on at least a portion, among a surface of the lip portion of the upper side glass run channel 15 that slides with the window pane 14 and the surface of the visible portion, where the operator slides his/her hand during the attachment operation, for the purpose of improving the sliding property.

According to the present embodiment described above, since the first covering portion 31 having a friction coefficient smaller than the lip portions 25 and 26 is formed on the surfaces of the lip portions 25 and 26 that slide with the window pane 14, it is possible to ensure the sliding property necessary for the up/down movement operation of the window pane 14. Moreover, since the first covering portion 31 formed on the surfaces of the lip portions 25 and 26 is harder than the second covering portion 32 formed on the surfaces of the visible portions 27 and 28, the sliding property is further enhanced, and the sliding property with respect to the window pane 14 can be further improved.

Further, the second covering portion 32 having a friction coefficient smaller than that of the lip portions 25, 26 is formed over the surfaces of the visible portions 27, 28 from the bending point 29 of the lip portions 25, 26 or the position the lip portions 25, 26 on the distal end side with respect to the bending point 29. Therefore, when the operator attaches the vertical side glass run channels 16, 17 to the window frame 12, the operator can easily slide portions from the root sides of the lip portions 25 and 26 to the surfaces of the visible portions 27 and 28, which are portions to be pushed in by his/her hand to slide along the longitudinal direction, and the attachment workability of the vertical side glass run channels 16 and 17 can be improved.

Moreover, the first covering portion 31 harder than the second covering portion 32 is formed on the distal end side of the lip portions 25, 26 with respect to the bending point 29 on the root sides of the lip portions 25, 26, and the bending point 29 on the root sides of the lip portions 25, 26 is not covered by the harder first covering portion 31. Therefore, the bending deformation on the root sides of the lip portions 25, 26 is not hindered, and an increase in reaction force against the bending deformation on the root sides of the lip portions 25, 26 can be prevented.

Furthermore, in the present embodiment, since the durometer hardness (type D) defined in JIS K7215 of the first covering portion 31, which is a covering portion of the lip portions 25 and 26, is set to be HDD 40 or more, the first covering portion 31 can have a predetermined sliding property with respect to the window pane 14. Further, since the durometer hardness of the first covering portion 31 is set to be HDD 60 or less, it is possible to prevent a decrease in flexibility of the lip portions 25 and 26 by the first covering portion 31.

Further, since the durometer hardness (type A) defined in JIS K7215 of the second covering portion 32, which is the covering portion of the visible portions 27 and 28, is set to be HDA 80 or more, it is possible to ensure the necessary sliding property of the visible portions 27 and 28 during the attachment operation of the vertical side glass run channels 16 and 17. Further, since the durometer hardness of the second covering portion 32 is set to be HDA 95 or less, even when the bending point 29 on the root sides of the lip portions 25 and 26 is covered with the second covering portion 32, the second covering portion 32 can prevent the lip portions 25 and 26 from being lowered in its bendability and deformability at the bending point 29.

In the present embodiment, the first covering portion 31 and the second covering portion 32 are formed to be in contact with each other, and the first covering portion 31 and the second covering portion 32 are continuously formed from the lip portions 25 and 26 to the visible portions 27 and 28 without a gap therebetween. Therefore, there is an advantage that the sliding property can be secured continuously from the lip portions 25 and 26 to the visible portions 27 and 28. However, the present invention may be configured such that the first covering portion 31 and the second covering portion 32 are not in contact with each other and there is a gap therebetween, and the intended object of the present invention can also be achieved in this case.

Moreover, since the thickness of the second covering portion 32 is made thinner than the thickness of the first covering portion 31, not only the bending deformation of the visible portions 27 and 28 in which the second covering portion 32 is formed is not hindered, but also the bending deformation on the root sides of the lip portions 25 and 26 is not hindered even when the bending point 29 of the lip portions 25 and 26 is covered with the second covering portion 32.

In the present embodiment, since the thickness of the first covering portion 31, which is the covering portion of the lip portions 25, 26, is set to 0.1 mm or more, even if the first covering portion 31 is worn due to the repetition of the up/down movement operation of the window pane 14, the first covering portion 31 can be left on the surfaces of the lip portions 25, 26, and the lip portions 25, 26 can always be easily slid with respect to the window pane 14. In addition, since the thickness of the first covering portion 31 is 0.4 mm or less, it is possible to prevent the lip portion itself from being lowered in its elastic deformability by the first covering portion 31.

Since the thickness of the second covering portion 32, which is the covering portion of the visible portions 27 and 28, is set to 0.01 mm or more, it is possible to ensure the necessary sliding property of the visible portions 27 and 28 during the attachment operation of the vertical side glass run channels 16 and 17. Further, since the thickness of the second covering portion 32 is less than 0.1 mm, even if the bending point 29 of the lip portions 25, 26 is covered with the second covering portion 32, it is possible to prevent the lip portions 25, 26 from being lowered in its bendability at the bending point 29.

The present invention is not limited to the configuration of the above embodiment. For example, cross-sectional shapes of the lip portions 25 and 26 and the visible portions 27 and 28 may be changed, a cross-sectional shape of the main body portion 24 may be changed, or the first covering portion 31 (the second covering portion 32) may not be formed on one of the lip portion 25 (the visible portion 27) on a vehicle interior side and the lip portion 26 (the visible portion 28) on a vehicle exterior side.

In addition, the present invention is not limited to a glass run channel of a front door, and can be configured by being applied to a glass run channel of another door such as a rear door, or the like, without departing from the gist thereof.

### REFERENCE SIGNS LIST

11: door
12: window frame
13: glass run channel assembly
14: window pane
15: upper side glass run channel
16: front vertical side glass run channel
17: rear vertical side glass run channel
21: sidewall portion on vehicle interior side
22: sidewall portion on vehicle exterior side
23: bottom wall portion
24: main body portion
25: lip portion on vehicle interior side
26: lip portion on vehicle exterior side
27: visible portion on vehicle interior side
28: visible portion on vehicle exterior side
29: bending point
31: first covering portion
32: second covering portion

1. A glass run channel made of an elastic polymer material, the glass run channel being configured to be attached along a window frame of a door panel of a vehicle and formed to be long to guide movement of a window pane, the glass run channel comprising:
a main body portion having a U-shaped cross-section, the main body portion comprising an inner sidewall portion configured to be disposed on a vehicle interior side, an outer sidewall portion configured to be disposed on a vehicle exterior side, and a bottom wall portion integrally connecting the inner sidewall portion and the outer sidewall portion;
an inner lip portion which is configured to be disposed on the vehicle interior side and elastically deformable, the inner lip portion protruding from an end of the inner side wall portion toward an inside of the main body portion;
an outer lip portion which is configured to be disposed on the vehicle exterior side and elastically deformable, the outer lip portion protruding from an end of the outer sidewall portion toward the inside of the main body portion; and
an inner visible portion which is configured to be disposed on the vehicle interior side and which is elastically deformable, the inner visible portion protruding from the end of the inner sidewall portion toward an outside of the main body portion; and
an outer visible portion which is configured to be disposed on the vehicle exterior side and which is elastically deformable, the outer visible portion protruding from the end of the outer sidewall portion toward the outside of the main body portion,
wherein a lip portion which is one or each of the inner lip portion and the outer lip portion is formed such that:
a bending point is located on a root side of the lip portion, the bending point at which the lip portion is bent when the lip portion is elastically deformed by sliding with the window pane at a time of moving up or down the window pane;
a first covering portion having a friction coefficient smaller than that of the lip portion is formed on a distal end side of the lip portion with respect to the bending point within a part of a surface of the lip portion, the part of the surface of the lip portion being configured to contact the window pane while the lip portion slides with the window pane; and
a second covering portion having a friction coefficient smaller than that of the lip portion is formed over a surface of the visible portion from the bending point of the lip portion or a position of the lip portion on the distal end side with respect to the bending point, and
wherein the first covering portion is formed to be harder than the second covering portion.

2. The glass run channel according to claim 1,
wherein the first covering portion has a first hardness of HDD 40 or more and HDD 60 or less, where the first hardness is a type-D durometer hardness defined in Japanese Industrial Standards K7215, and
wherein the second covering portion has a second hardness of HDA 80 or more and HDA 95 or less, where the second hardness is a type-A durometer hardness defined in Japanese Industrial Standards K7215.

3. The glass run channel according to claim 1,
wherein the first covering portion and the second covering portion are formed to be in contact with each other.

4. The glass run channel according to claim 1,
wherein a second thickness of the second covering portion is smaller than a first thickness of the first covering portion.

5. The glass run channel according to claim 4,
wherein the first thickness is 0.1 mm or more and 0.4 mm or less, and
wherein the second thickness is 0.01 mm or more and less than 0.1 mm.

6. A glass run channel assembly comprising
an upper side glass run channel attached along an upper side of a window frame of a door panel of a vehicle; and
a vertical side glass run channel attached along a vertical side of the window frame, wherein
at least one of the upper side glass run channel and the vertical side glass run channel comprises the glass run channel according to claim 1.
